(19) United States
(12) Patent Application Publication
(10) Pub. No.: US 2024/0157187 A1
(43) Pub. Date: May 16, 2024

(54) EXERCISE BAR

(71) Applicant: Dany CHIASSON, Toronto (CA)

(72) Inventor: Dany CHIASSON, Toronto (CA)

(21) Appl. No.: 18/508,674

(22) Filed: Nov. 14, 2023

Related U.S. Application Data
(60) Provisional application No. 63/383,533, filed on Nov. 14, 2022.

(51) Int. Cl. A63B 21/072; B27M 1/08; B27M 3/00

(52) U.S. Cl. CPC A63B 21/072; B27M 1/08; B27M 3/002

(57) ABSTRACT

An example of an exercise bar is provided. The exercise bar includes a first piece of wood having a first substantially flat surface with a first recess formed in the first substantially flat surface. The exercise bar also includes a second piece of wood having a second substantially flat surface. The second substantially flat surface is configured to mate with the first substantially flat surface and includes a second recess formed in the second substantially flat surface. The second recess is to align with the first recess. Furthermore, the exercise bar includes a weight disposed between the first piece of wood and the second piece of wood. A first portion of the weight fits in the first recess and a second portion of the weight fits in the second recess.

### CROSS-REFERENCE TO RELATED APPLICATION

This application claims priority to U.S. Provisional Patent Application No. 63/383,533, filed Nov. 14, 2022, which is incorporated by reference in its entirety.

### BACKGROUND

Exercise equipment is often designed to be used to improve strength, flexibility, or speed and quickness. Although exercise equipment may be relatively large and complex and include mechanical and electronic parts, other equipment may be simple, compact and ergonomically appropriate for certain uses.

### BRIEF DESCRIPTION OF THE DRAWINGS

Reference will now be made, by way of example only, to the accompanying drawings in which:

FIG. 1 is an exploded view of an example of an exercise bar;

FIG. 2 is a side view of the example of an exercise bar shown in FIG. 1;

FIG. 3 is a cross-sectional view of the example of an exercise bar shown in FIG. 1 along the plane 3-3;

FIG. 4 is an exploded view of another example of an exercise bar;

FIG. 5A is a top view of the example of an exercise bar shown in FIG. 4;

FIG. 5B is a side view of the example of an exercise bar shown in FIG. 4;

FIG. 5C is a end view of the example of an exercise bar shown in FIG. 4;

FIG. 6 is an exploded view of another example of an exercise bar;

FIG. 7 is a cross-sectional view of the example of an exercise bar shown in FIG. 6 along the plane 7-7; and

FIG. 8 is a flowchart of an example process of manufacturing an exercise bar.

### DETAILED DESCRIPTION

As used herein, any usage of terms that suggest an absolute orientation (e.g. “top”, “bottom”, “up”, “down”, “left”, “right”, “height”, “length”, “width”, etc.) may be for illustrative convenience and refer to the orientation shown in a particular figure. However, such terms are not to be construed in a limiting sense as it is contemplated that various components will, in practice, be utilized in orientations that are the same as, or different than those described or shown.

Exercises to improve flexibility, strength or quickness of motion may be carried out by a person without any equipment or accessories. Alternatively, different exercise equipment is usable to assist a person in achieving certain exercise plans and goals. Some such equipment is large, bulky and may be highly specific to particular exercise regimes and objectives. For example, the strengthening of particular muscle groups may be achieved by using exercise machines that have specific weights, pulleys and handles.

However, there are also simple devices which may be used for exercising and which are intended to be gripped single-handed or with two hands. Exercise bars are one type of such a device. Exercise bars are known to be generally configured as rods of various lengths and are typically metallic and may include a rubber or plastic outer sheath over the exercise bars.

The dimensions and weight of exercise bars will impact how the bars are able to be used in various exercises. Further, the design and material selected for an exercise bar may impact the functionality of the exercise bar. The attractiveness of the appearance and feel of the exercise bar may impact the initial interest in, as well as the continued dedication to, exercises carried out with the exercise bar. An appropriately designed exercise bar will provide advantageous characteristics of size, weight and ergonomics.

An exercise bar 50, to facilitate mobility exercises, muscle training, sport warm-up, flexibility, balance and coordination, and other exercises, is provided. The exercise bar 50 generally includes a wooden body formed by connecting multiple pieces of wood along with an interior weight, such as a metallic insert. The exercise bar 50 is to be comfortably gripped by one or two hands. For example, the exercise bar 50 may have a generally rectangular cross-sectional shape with rounded corners and edges.

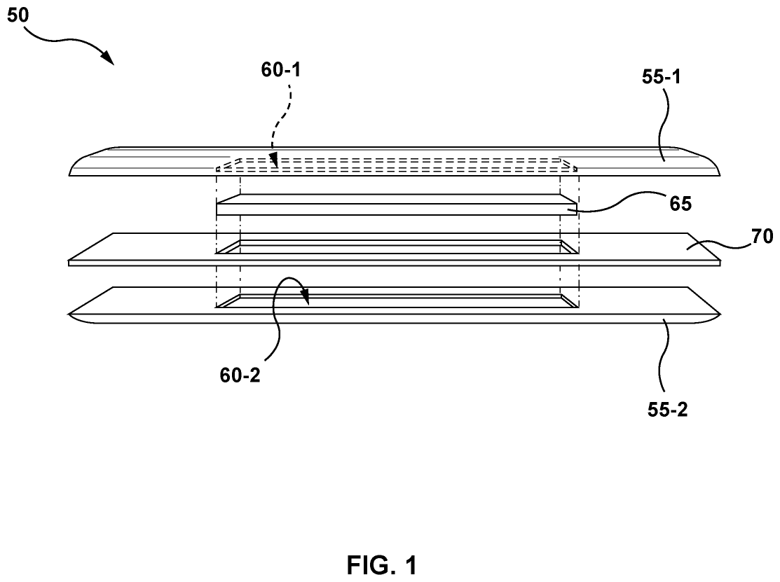

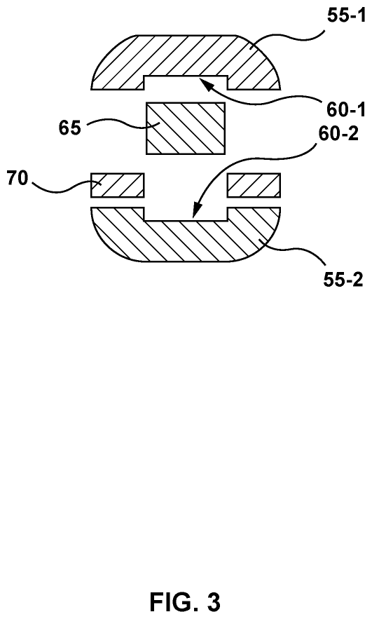

Referring to FIGS. 1, 2, and 3, an example of an exercise bar 50 is provided. The exercise bar 50, also referred to as a fitness tool, may include a first piece of wood 55-1 and second piece of wood 55-2 (generically, these pieces of wood are referred to herein as “pieces of wood 55” and collectively they are referred to as “piece of wood 55”, this nomenclature is used elsewhere in this description) in FIG. 1. These may be configured as shown to be assembled together so as to define a wooden body portion. Accordingly, the pieces of wood 55 may each have a substantially flat surface to mate with the substantially flat surface of the other piece of wood 55. In other examples, it is to be understood by a person of skill with the benefit of this description that the pieces of wood 55 may have other complimentary shapes that may be mated to for the wooden body portion. In the present example, the exercise bar 50 has a generally rectangular cross-section in both side and end profiles, with rounded corners. The combination of relative dimensions of exercise bar 50 having rounded corner arrangements, may be seen in FIG. 3. The combination of a wooden body and exterior surface, and the rounded corners of exercise bar 50 provide improved gripping by hand. In addition, the shape improves the feel and comfort of the exercise bar 50 when in use.

As is shown in FIG. 1, exercise bar 50 includes a weight 65. The weight 65 is not particularly limited and may be any high-density material to increase the weight of the exercise bar 50 without affecting the external dimensions. In the present example, the weight 65 is a steel insert, such as steel bar. In other examples, the weight 65 may be made from another type of metal, such as lead, copper, brass, or other suitable material. In other examples, the weight 65 may be a polymer or other high-density material. The weight 65 is provided to enable a combination of size and weight, while allowing for the choice of wood as the primary external material for the wooden body of the exercise bar 50. A target ratio of outer dimensions of the wooden body of exercise bar 50 to the overall weight of the bar may be obtained, and is dependent on the application, such as the intended exercise.

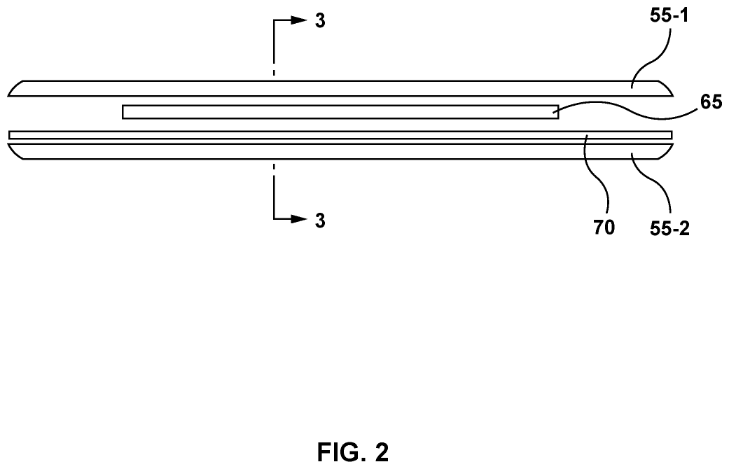

Referring to FIG. 2, a side view of the exercise bar 50 is shown. The dimensions of the exercise bar 50 are not particularly limited and may be varied depending on the application. In the present example, the length of exercise bar 50 is about 26 inches with a total height of about 1.25 inches. Referring to FIG. 3, the cross-section of the exercise bar 50 is shown and the width of the exercise bar 50 is about 1.75 inches. The radius of curvature of the rounded corner of the rectangular cross-section is substantially uniform and is relatively short to provide an appropriate fit for a typical human hand using exercise bar 50. It is to be appreciated by a person of skill with the benefit of this description that the dimensions and the radius of curvature may be varied for different hand sizes to further improve comfort. The manner by which the exercise bar 50 is rounded is not particularly limited but the finished surface is to provide a reliably comfortable and functional grip for the user. Accordingly, the surface is to be substantially smooth while providing a firm grip that would not easily slip. The exercise bar 50 has height and width dimensions that are appreciably different from each other to provide an orientation when handled in use.

The exercise bar 50 includes a relatively large longitudinal dimension in the present example. In other examples, the lengths may be varied to about 17 inches and about 8 inches. The dimensions of height and width for the long exercise bar 50 may not be modified for the shorter exercise bars described above. Accordingly, the shortened exercise bars may be intended for single-hand use whereas the present example of the exercise bar 50 may be intended for use with both hands. For example, a pair of smaller exercise bars may be utilized at the same time by the person carrying out exercises, such as a dynamic strengthening tool used when walking. Larger exercise bars may be used in other exercises, such as for personal training, physical therapy, and home workouts.

In the present example, the exercise bar 50 includes an optional intermediate layer 70. The intermediate layer 70 is disposed between the pieces of wood 55 and generally configured to mate with the flat surfaces of the pieces of wood to facilitate mating of the pieces of wood 55. The intermediate layer 70 is not particularly limited and may be made of a similar piece of wood material as the pieces of wood 55. In other examples, the intermediate layer 70 may be made from other materials such as plastics or metals. The intermediate layer 70 may also include a unique design or color scheme to provide an identification mechanism for the exercise bar 50, such as to identify a weight or size of the exercise bar 50. It is to be understood by a person of skill with the benefit of this description that the intermediate layer 70 is optional and may be excluded in some examples where the pieces of wood 55 may directly mate with each other.

In the present example, the apparatus 50 has a total weight of about 4.0 pounds. The pieces of wood 55 may be a hard wood with a combined total weight of about 1.3 pounds. The weight 65 may be a steel bar with a weight of about 2.7 pounds. In another example, the exercise bar 50 may be substituted with another having a length of about 17 inches with the wood pieces weighing about 0.75 pounds and the weight weighing about 1.75 pounds. For an exercise bar with a length of about 8.0 inches, the pieces of wood may weigh about 0.3 pounds and the weight may weigh about 0.7 pounds.

As may be seen from these example weights, the weight 65 may provide the exercise bar 50 with the majority of its overall weight. A weighted wooden exercise bar provides for additional engagement for muscles (primarily those of the upper body) in comparison with an unweighted bar of the same size. By using the weight 65 within the interior of the exercise bar 50, the pieces of wood 55 on the exterior retain a relatively uniform exterior appearance and surface texture, which may be smooth, while achieving an overall weight better suited for certain exercises. The wood exterior provides a natural, easy to clean, waterproof and non-toxic exercise bar 50.

Referring again to FIG. 1, the manner in which the exercise bar 50 may be configured and assembled may be understood. In the present example, there are effectively three layers used to form the exercise bar 50. The intermediate layer 70 is about 0.25 inches, which is thinner than weight 65. The weight 65 may have a height of about 0.5 inches, a width of about 0.75 inches, and a length of about 17 inches. The exercise bar 50 in this example may have an overall length of about 26 inches.

The piece of wood 55-1 includes a recess 60-1 formed in the substantially flat surface and the piece of wood 55-2 includes another recess 60-2 formed in the substantially flat surface. The recesses 60-1 and 60-2 (generically, these recesses are referred to herein as “recess 60” and collectively they are referred to as “recesses 60”, this nomenclature is used elsewhere in this description) are generally configured to align with each other. The dimensions of the recesses 60 may be varied and designed based on the size of the weight 65. In the present example, each of the recesses 60 are configured to receive upper and lower portions of weight 65. In the present example, the recess 60-1 and the recess 60-2 are both about 0.125 inches deep. The optional intermediate layer 70 includes a cut-out through which the weight 65 may be received. The cut-out in the intermediate layer 70 may be larger than the length and width of the weight 65, but the relative dimensions may be selected to arrange for a slip fit of these parts. As will be appreciated by a person of skill with the benefit of this description, the shape, material and dimensions of the weight 65 can be modified to differ from what is shown in FIG. 1. In the present example, the weight 65 is metallic and is enclosed entirely in the pieces of wood 55 of exercise bar 50 when assembled.

In some examples, the optional intermediate layer 70 of exercise bar 50 may have multiple discrete portions to serve as an identifier marking. The identifier marking is not particularly limited and may be any marking, such as writing, symbols or a color-coding system. For example, a middle portion may have a color different from the end portions of the intermediate layer 70. This provides for a design accent as well as a cue as to the orientation of exercise bar 50 and, if desired, an indication of the size (and therefore weight) of the weight 65. The identifier marking may also indicate alternative weightings of the same outer dimensions be provided. It is to be appreciated by a person of skill with the benefit of this description that the weight 65 may be made of any suitable material that will provide the desired weight to exercise bar 50. Further alternatives to the example provided in the three-part sandwich construction of exercise bar 50 may be employed to provide the combination of a wooden body and weighted insert.

The exercise bar 50 is assembled into a completed form by using an appropriate adhesive to affix the layers into a single composite structure. For example, carpenter's glue, or an epoxy may be used. In other examples, the parts may also be connected by using wood joints, fasteners or other mechanism. However, adhesives provide for a completed structure without overly noticeable joins, seams, or bolts.

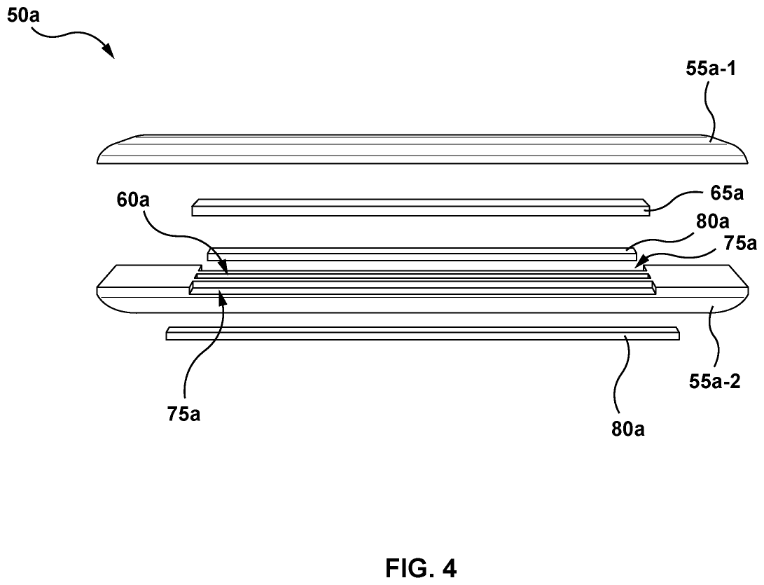

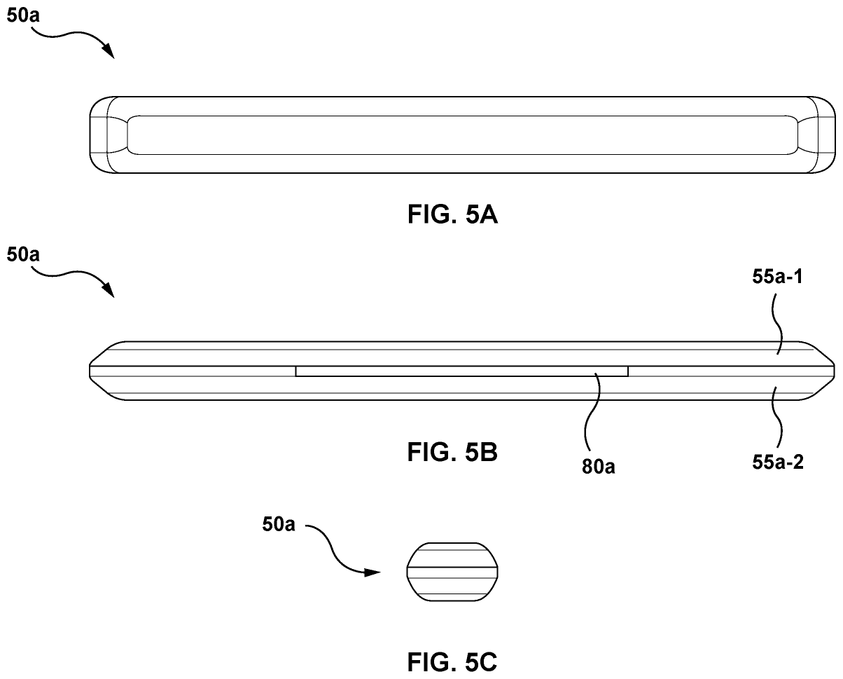

Referring to FIG. 4, an exploded view of another exercise bar 50a is provided. Like components of the exercise bar 50a bear like reference to their counterparts in the exercise bar 50, except followed by the suffix “a”. In the present example, the exercise bar 50a includes a first piece of wood 55a-1 and second piece of wood 55a-2 (generically, these pieces of wood are referred to herein as “pieces of wood 55a” and collectively they are referred to as “piece of wood 55a”) with recesses 60a-1 and 60a, marking recesses 75a, and additional pieces of wood as identifier markings 80a. FIGS. 5A, 5B, and 5C show exterior views of the exercise bar 50a after assembly.

In the present example, the outer dimension and shape of the exercise bar 50a may be the same as is described above for exercise bar 50. The weight 65a may similarly be the same dimension and material as is described above for the weight. The surfaces of the pieces of wood 55a which face each other as shown in FIG. 4 may be considered interior surfaces as in the assembled exercise bar 50a these surfaces may be secured together using adhesive.

In the present example, the exercise bar 50a is provided with three cut outs in the substantially flat interior surface of the piece of wood 55a-2. The two exterior cut outs define marking recesses 75a into which an identifier marking 80a may be secured (by adhesive, for example). The identifier marking 80a is not particularly limited and may be two wooden strips with a predefined color that is part of a color-coding system. The identifier markings 80a achieve a similar functional and aesthetic objective as is set out above with respect to the identifier marking of the intermediate layer 70. For example, the identifier marking 80a may provide orientation and positional information for the user of exercise bar 50a as well as for aesthetic purposes. The central cut out in piece of wood 55a-2 defines a pair of rails dividing the recess 60a-2 from the marking recesses 75a. Accordingly, the rails that are formed in the piece of wood 55a-2 form part of the substantially flat surface and provides more surface area for the adhesive to bond. In addition, the rails provide guides to position the weight 65a into the recess 60a-2 by engaging a portion of the weight 65a.

In particular, the weight 65a is intended to be received in both a recess defined in the substantially flat interior surface of the piece of wood 55a-1 and the recess 60a-2 cut out in piece of wood 55a-2, respectively. The identifier markings 80a are of a dimension to align at their outer faces with the outer surface of the exercise bar 50a, when the exercise bar 50a is assembled. In the present example, the central cut out defining the recess 60a-2 for the weight 65a has a greater depth than the marking recesses 75a which are to receive the identifier markings 80a.

The rails are defined by the cut outs in the piece of wood 55a-1 which are the same height as the distal planar portions of the interior surface of the piece of wood 55a-2. The relative sizes of the weight 65a and the corresponding recess permits the weight 65a to extend higher than the top of the rails and the planar portions of piece of wood 55a-2 when in place in the recess 60a-2.

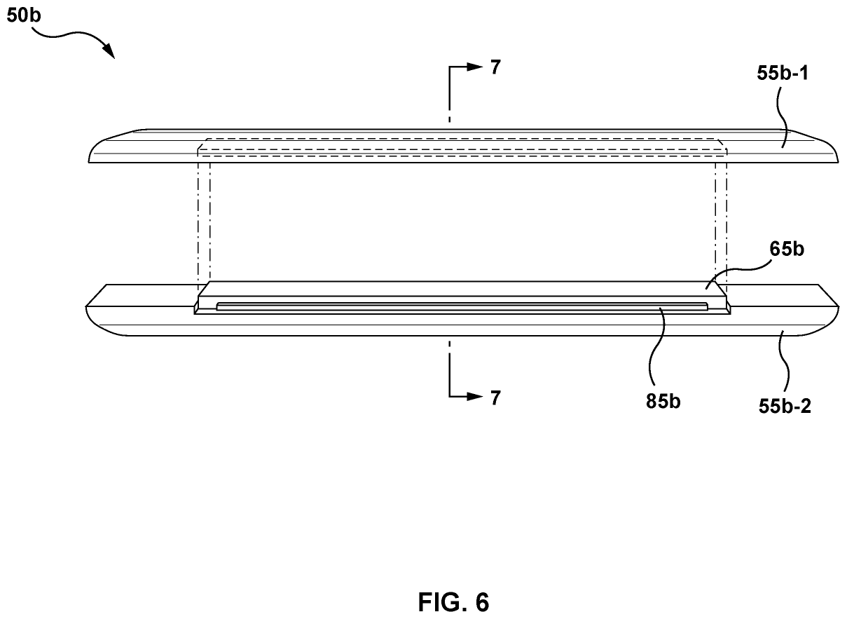

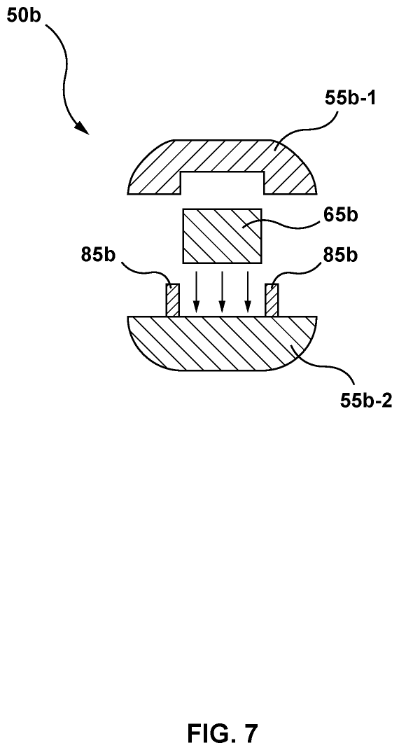

Referring to FIG. 6, an exploded view of another exercise bar 50b is provided. Like components of the exercise bar 50b bear like reference to their counterparts in the exercise bar 50a, except followed by the suffix “b”. In the present example, the exercise bar 50b includes a first piece of wood 55b-1 and second piece of wood 55b-2 (generically, these pieces of wood are referred to herein as “pieces of wood 55b” and collectively they are referred to as “piece of wood 55b”), a weight 65b, and wood strips 85b. FIG. 7 shows a cross section of the exercise bar 50b.

It is to be appreciated by a person of skill with the benefit of this description that the wood strips 85b are not limited. The wood strips 85b define outwardly facing surfaces used to both align the identifier marking 80a as well as to provide surfaces for the identifier markings (not shown) to be adhered to in the assembly of exercise bar 50b. Although previous examples show rails extending the length of the recess 60a-2, it is possible to define rails which do not fully extend the length or which are discontinuous such as the wood strips 85b, which functions as rails in the present example. The size of the wood strips 85b are also not limited and may be dimensioned to allow for the insertion of another piece of wood (not shown) to act as an identifier marking.

When fully assembled, exercise bar 50b may have a similar appearance, dimension and weight as exercise bar 50 but the intermediate layer 70 is effectively replaced by the identifier markings 80a which cooperate with the configuration of the end parts of piece of wood 55b-2. The depths of the recesses in the pieces of wood 55b are also shown for the weight 65b in the example of FIG. 6. In the present example, the exercise bar 55b has a length of approximately 17 inches or 26 inches. However, it is to be appreciated that other lengths are possible for exercise bar 50b. The dimensions, weight and profile of exercise bar 50b may vary somewhat but those characteristics of the assembled exercise bar are expected to be similar to the example of the exercise bar.

An alternative example of exercise bar 50b may be provided with an alignment structure (not shown) on a piece of wood, such as a projection on the planar interior surface and a complementary alignment structure, such as corresponding recess in the other piece of wood (neither projection nor recess shown) designed to aid in alignment of the pieces of wood in assembly and to provide additional strength to the assembled exercise bar 50b. As a specific example, a piece of wood may have a cylindrical projection corresponding to a similarly shaped recess in another piece of wood, although other shapes and arrangements may be utilized.

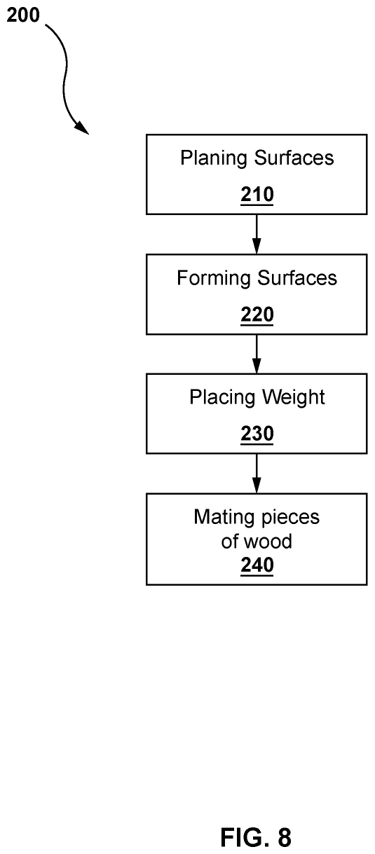

Referring to FIG. 8, a flowchart of a method of manufacturing the exercise bar. In order to assist in the explanation of method 200, it will be assumed that method 200 may be performed by the exercise bar 50. Indeed, the method 200 may be one way in which the exercise bar 50 may be operated. Furthermore, the following discussion of method 200 may lead to a further understanding of the exercise bar 50 and its components. In addition, it is to be emphasized, that method 200 may not be performed in the exact sequence as shown, and various blocks may be performed in parallel rather than in sequence, or in a different sequence altogether.

Beginning at block 210, pieces of wood are planed to form substantially flat surfaces on two pieces of wood. The substantially flat surfaces are to mate the pieces of wood 55 together to form the exercise bar 50. Recesses 60 are then formed or dug into the substantially flat surfaces of the pieces of wood 55 at block 220.

Block 230 involves placing the weight 65 between the pieces of wood 55. The manner by which the weight 65 is placed between the pieces of wood is not limited. In the present example, portions of the weight are fit into the recesses 60 on each piece of wood 55. Accordingly, the weight 65 may be used to align the pieces of wood 55. Once the pieces of wood 55 are aligned, the pieces of wood 55 are mated at block 240. The manner by which the pieces of wood 55 are mated is not particularly limited. For example, carpenter's glue, or an epoxy may be used. In other examples, the parts may also be connected using wood joints, fasteners or other mechanism. However, adhesives provide for a completed structure without overly noticeable joins, seams, or bolts.

The exercise bars described above may be used in custom-designed exercises or may be used in modified yoga, Pilates, Qigong, barre exercises and the like. It should be recognized that features and aspects of the various examples provided above may be combined into further examples that also fall within the scope of the present disclosure.

What is claimed is:

1. An exercise bar comprising:
a first piece of wood having a first substantially flat surface;
a first recess formed in the first substantially flat surface;
a second piece of wood having a second substantially flat surface, wherein the second substantially flat surface is configured to mate with the first substantially flat surface;
a second recess formed in the second substantially flat surface, wherein the second recess is to align with the first recess; and
a weight disposed between the first piece of wood and the second piece of wood, wherein a first portion of the weight fits in the first recess and a second portion of the weight fits in the second recess.

2. The exercise bar of claim 1, wherein the weight is a steel bar.

3. The exercise bar of claim 1, further comprising an identifier marking.

4. The exercise bar of claim 3, wherein the identifier marking is a separate piece of wood.

5. The exercise bar of claim 3, wherein the identifier marking is colored.

6. The exercise bar of claim 3, further comprising an intermediate layer disposed between the first piece of wood and the second piece of wood, wherein the identifier marking is disposed on the intermediate layer.

7. The exercise bar of claim 6, wherein the first piece of wood includes a marking recess to receive the identifier marking.

8. The exercise bar of claim 1, further comprising a first alignment structure disposed on the first piece of wood and a second alignment structure disposed on the second piece of wood, wherein the first alignment structure and the second alignment structure mate to align the first piece of wood to the second piece of wood.

9. The exercise bar of claim 1, further comprising a plurality of rails formed in the first piece of wood to form part of the first substantially flat surface, wherein the plurality of rails are to position the first portion of the weight in the first recess.

10. The exercise bar of claim 1, further comprising a plurality of wood strips to position the first portion of the weight in the first recess.

11. The exercise bar of claim 1, wherein the first piece of wood and the second piece of wood are rounded to improve grip.

12. A method of manufacturing an exercise bar, the method comprising:
planing a first substantially flat surface on a first piece of wood;
forming a first recess in the first substantially flat surface;
planing a second substantially flat surface on a second piece of wood;
forming a second recess in the second substantially flat surface;
placing a weight between the first piece of wood and the second piece of wood, wherein a first portion of the weight fits in the first recess and a second portion of the weight fits in the second recess; and
mating the first piece of wood and the second piece of wood.

13. The method of claim 12, further comprising applying an identifier marking.

14. The method of claim 13, wherein the identifier marking is colored.

15. The method of claim 14, further comprising inserting an intermediate layer between the first piece of wood and the second piece of wood, wherein the identifier marking is disposed on the intermediate layer.

16. The method of claim 14, further comprising inserting the identifying marking in a marking recess, wherein the marking recess is formed on the first piece of wood.

17. The method of claim 12, further comprising aligning the first piece of wood with the second piece of wood before mating.

18. The method of claim 17, wherein aligning comprises using a complimentary alignment structure disposed on the first piece of wood and the second piece of wood.

19. The method of claim 12, further comprising inserting a plurality of wood strips in the first recess to position the first portion of the weight.

20. The method of claim 12, further comprising rounding the first piece of wood and the second piece of wood to improve grip.
